(19) United States
(12) Patent Application Publication
(10) Pub. No.: US 2004/0072576 A1
(43) Pub. Date: Apr. 15, 2004

(54) Method and system for transferring gps data in mobile network

(76) Inventors: Pan Nuutinen, Espoo (FI); Markus Maanoja, Espoo (FI); Miika Vuorisalo, Viiala (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/450,299

(22) PCT Filed: Dec. 21, 2000
(86) PCT No.: PCT/EP00/13120

(51) Int. Cl. H04Q 7/00

(52) U.S. Cl. 455/456.1

(57) ABSTRACT

The invention proposes a method and system for transferring location Data in a mobile network, preferably for assisting in locating one or more Mobile Station(s) in the network, the network comprising at least one receiver outputting raw location data, and at least one location entity. The raw location data are transferred from the receiver to the location entity using one or more signalling protocol(s), e.g. LLP. The location entity is adapted to process the received raw location data so as to generate assistance data which are transferred to the mobile station. The invention is preferably used in a network-assisted mobile-based GPS location method and system allowing to detect the present location of a Mobile Station.

### FIELD AND BACKGROUND OF THE INVENTION

The invention generally refers to the locating of Mobile Station(s) in networks such as cellular communications networks. The term “Mobile Station(s)” as used here intends to cover all types of mobile devices such as mobile phones, portable computers, User Equipment(s) (UEs) etc.

In particular, but not exclusively, the invention relates to network-assisted mobile based GPS location method and system allowing to detect the present location of a Mobile Station (MS). For performing such a location method, GPS assistance data are necessary from the network. These GPS assistance data are usually directly sent to the MS from the base station e.g. in a positioning measurement request.

When, however, as an example, a SMLC (Serving Mobile Location Centre) should be adapted to generate the GPS assistance data for MS (Mobile Station), the SLMC needs raw GPS satellite data for generation of the GPS assistance data. Transfer of the generated GPS assistance data from SMLC to MS can be implemented in accordance with standardized information transmission to a MS, for instance by including this GPS assistance data in a position measuring request. Problems however arise with regard to the acquisition of raw GPS satellite data by SMLC.

### SUMMARY OF THE INVENTION

The invention provides a method and/or system as defined in the independent claims or any of the dependent claims.

The invention generally provides a method and system to transfer raw location data, e.g.GPS data, (i.e. subframes) in telecom network.

The invention is also applicable to, and intends to cover, networks of other types such as 3G (Third Generation) networks and IP-RAN (Internet Protocol-based Radio Access Network), where SMLC is integrated in SRNC (Serving Radio Network Controller).

According to a preferred embodiment of the invention, one or more of the signalling protocols, e.g. LLP, of the communication network are used to transfer the raw location data, preferably GPS satellite data (subframes) from source (e.g. BS or LMU) to SMLC(s) which uses this data e.g. for generating GPS assistance data e.g. for MS. Communication network may consist of e.g. core network and radio network. The used signalling protocol preferably is a location service protocol such as LLP protocol (LMU LCS Protocol).

Preferably, one or more dedicated reference receivers, e.g. GPS receivers, are provided on known location (e.g. in LMU (Location Measurement Unit) on BTS-site) which send raw location data, e.g. GPS subframes, to one or more SMLCs through already existing communication network (e.g. Abis).

The SMLC(s) may be assigned to e.g. a BTS (Base Transceiver Station) and/or a certain reference area. The reference receiver(s) is/are raw data source of this particular reference area.

The SMLC(s) therefore need not be equipped with own GPS receiver or reference GPS receiver.

The SMLC(s) may send acquired raw GPS satellite data in communication network (e.g. through the core network) to other SMLC(s) which have no direct connection to reference GPS receiver. The SMLC(s) may send this raw GPS satellite data to the other SMLC(s) using one or more signalling protocol(s) of the telecom network. The signalling protocol used by the location entity to transfer the raw location data to the another location entity may be a control protocol, e.g. SMLCPP (SMLC Peer Protocol).

### BRIEF DESCRIPTION OF THE DRAWINGS

FIG. 1 illustrates an embodiment in accordance with the present invention with 2G terms, and

FIG. 2 shows the signal flows and method steps of an embodiment in accordance with the present invention.

### DETAILED DESCRIPTION OF PREFERRED EMBODIMENTS OF THE INVENTION

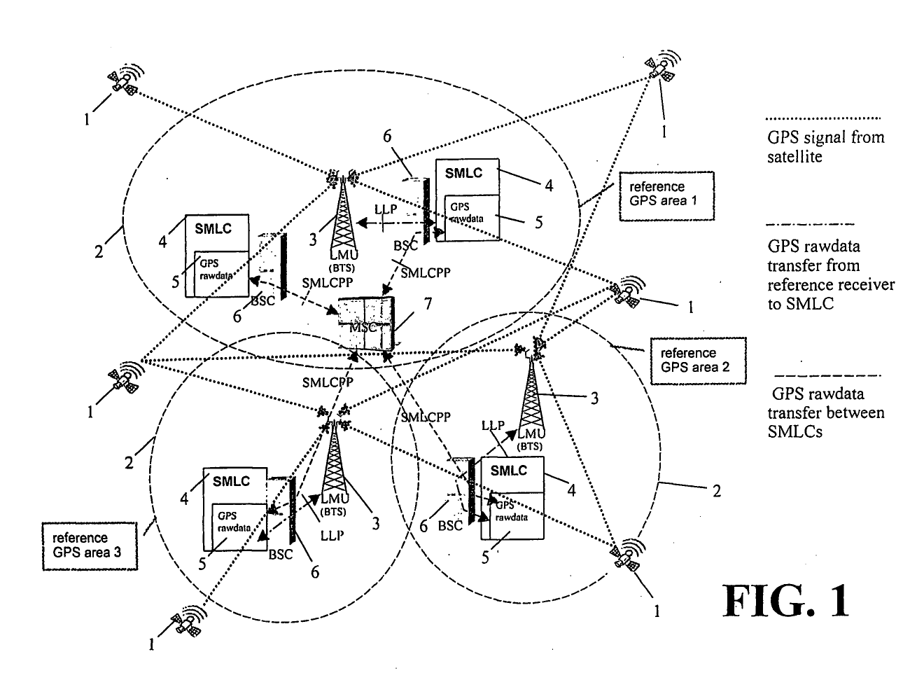

FIG. 1 shows an embodiment of the invention and illustrates a reference GPS network. FIG. 1 shows a plurality of Reference GPS areas (2) (three reference GPS areas 1,2,3 are shown) which are supplied with GPS signals (raw data) from a plurality of satellites (1). Each reference GPS area (2) comprises at least one BTS (Base Transceiver Station) (3).

Each reference GPS area comprises one (or more) dedicated reference GPS receiver which receives signals from at least four satellites (1) as represented by dotted lines. This GPS receiver is arranged at a known location, preferably in LMU (Location Measurement Unit) on the site of the BTS (3) of this reference GPS area. The reference GPS receiver(s) is/are GPS raw data source of this particular reference GPS area and transmits this GPS raw data (e.g. sub-frames) to one or more SMLC assigned to the same reference GPS area as the GPS receiver. A storage and/or processing means (5) included in, or cooperating with, its assigned SMLC (4) stores and/or processes the received GPS raw data so as to generate GPS assistance data for Assisted GPS allowing Network Assisted GPS Support e.g. as defined by respective standards such as ETSI. The manner of generation of GPS assistance data from raw GPS satellite data is known per se and can be used in the SMLC (4) in a similar or identical manner as e.g. in a base station (BS) or LMU (Location Measurement Unit) or the like.

The GPS subframes (raw data) are sent from the reference GPS receiver to the SMLC(s) (4) through already existing telecom network or backbone (e.g. Abis). The dot-and-dash lines represent GPS rawdata transfer from reference GPS receiver to SMLC (4).

Each BTS (3) is assigned to at least one BSC (Base Station Controller) (6) for handling the communication between the network entities such as BTS (3), SMLC (4), and MSC (Mobile Switching Centre) (7) interconnecting the reference GPS areas and cells. As shown in FIG. 1, reference GPS area 1 comprises two BSCs (6) whereas the other reference GPS areas include only one BSC (6).

When SMLCs (4) of different areas or cells intend to communicate with each other, e.g. for transferring GPS raw data or assistance data, the connection is established via MSC (7). The dashed lines represent the GPS rawdata transfer between SMLCs (4).

In FIG. 1, interfaces (protocols) are named like in 2G (Second Generation) type networks, but the invention intends to cover also other types of networks (e.g. 3G and All-IP). All of those protocols can be used to transfer raw GPS data. In accordance with one of the preferred aspects of this embodiment of the invention, GPS reference data are transported from LMU (3) to SMLC (4) over the existing standardised interface. As an example shown in FIG. 1, LLP protocol can be used for transporting the GPS reference data (or GPS raw data) from LMU to SLMC (4)(LLP means “LMU LCS Protocol”, LCS stands for “Location Service”).

For communication between SMLCs (4) e.g. via MSC (7), SMLCPP (SMLCPP, SMLC Peer Protocol) is preferably used.

A basic feature of this embodiment is thus to use the signalling protocols of the communication network to transfer raw GPS satellite data (subframes) from source (e.g. Base Station or SMLC (4)) to SMLC(s) (4) which use the data for generation of GPS assistance data for an MS (Mobile Station).

In another embodiment, the interface between SMLC (4) and MSC (7) may e.g. be the Ls-interface. Signaling on the Ls interface may e.g. use BSSAP-LE. The interface between BSC (6) and SMLC (4) can be a Lb-interface. The signalling on this interface may likewise use BSSAP-LE. The interface between Peer SMLCs (4) can e.g. be an Lp-interface. Both NSS and BSS-based SMLCs (4) may support the Lp interface to enable access to information and resources owned by another SMLC (4). Signalling on this interface may likewise use BSSAPP-LE, or SMLCPP.

The GPS receivers preferably are installed within 100 to 300 km radius. Since base stations (BSs) have fixed co-ordinates, the GPS receiver(s) may preferably be positioned e.g. in or at a LMU (Location Measurement Unit) on BS-site. BS can then send GPS subframes to SMLC (4) through already existing interface (e.g. Abis, Lub).

As an example, GPS raw data from each satellite are subframes (each 300 bit), and GPS raw data sending rate from satellite is 50 bit/s. The needed transfer rate for 12 satellites rawdata will then be 600 bit/s (75 byte/s). Calculations and simulations show that these data and data rates can be transferred using the teaching of the present invention without problems. These data can be transferred e.g. through Q1 interface.

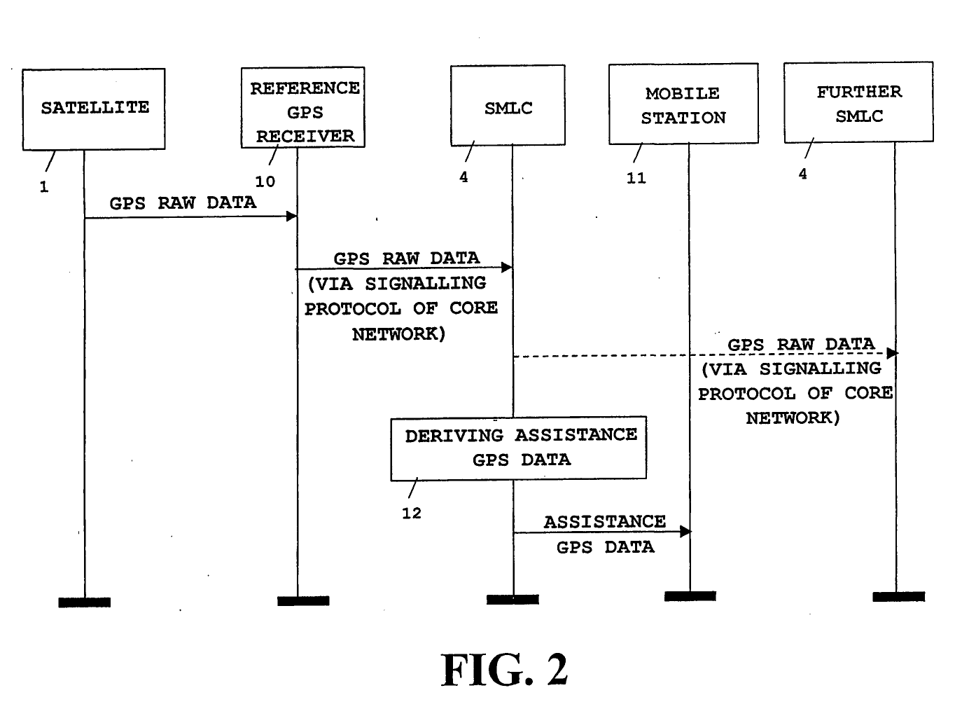

FIG. 2 illustrates method steps and data flow in an embodiment of the invention such as the one shown in FIG. 1. A satellite (1) sends GPS raw data to a reference GPS receiver (10) installed e.g. in the base station or BTS (3) of reference GPS area (2). The GPS receiver (10) transfers this GPS raw data in unprocessed or eventually preprocessed form to the SMLC (4) via a signalling protocol of the communication network. The data sent from receiver (10) to SMLC (4) may additionally include error correction (or indication) data for correcting or indicating location detection errors detected by the GPS reference receiver so as to form a Differential GPS (DGPS) system.

The SMLC (4) performs a data processing step 12 for deriving Assistance GPS data from the received GPS raw data. This Assistance GPS data may then be sent to one or more mobile stations (11) attached to the communications network including one or more of the BTSs (3).

Further, as shown in FIG. 2, the SMLC (4) may transmit the GPS raw data (and/or the Assistance GPS data) to another SMLC (4) using an appropriate signalling protocol of the communication network.

The invention may e.g. be used in network assisted MS based GPS location in different products in different generations (e.g. in 2G, in 3G or in All IP).

Using existing cellular signalling backbone in accordance with a preferred implementation of the invention is an easy, reliable and economical solution for delivering GPS data. Technically the idea can be implemented e.g. by using or extending SMLCPP protocol similarly to RIT (Radio Interface Timing) information exchange.

Although the invention has been described above with reference to specific embodiments, the invention likewise covers any modifications, amendments, omissions etc of the above teaching.

1. Method for transferring location information in a mobile network, preferably for assisting in locating one or more Mobile Station(s) in the network, the network comprising at least one receiver outputting raw location data, and at least one location entity,
wherein the raw location data are transferred from the receiver to the location entity using one or more signalling protocol(s).

2. Method according to claim 1, wherein the location information is received from a GPS system.

3. Method according to claim 1 or 2, wherein the raw location data is GPS raw data.

4. Method according to any one of the preceding claims, wherein the location entity processes the received raw location data so as to generate assistance data, preferably GPS assistance data.

5. Method according to claim 4, wherein the location entity transfers the assistance data to the mobile station.

6. Method according to any one of the preceding claims, wherein the location entity is a SMLC (Serving Mobile Location Centre).

7. Method according to any one of the preceding claims, wherein the mobile Station is a mobile phone, portable computer, or User Equipment (UE).

8. Method according to any one of the preceding claims, wherein the network is a cellular communications networks.

9. Method according to any one of the preceding claims, wherein the signalling protocol is a signalling protocol of the communication network.

10. Method according to any one of the preceding claims, wherein the signalling protocol is a signalling protocol used in core network.

11. Method according to any one of the preceding claims, wherein the signalling protocol is a signalling protocol used in radio network.

12. Method according to any one of the preceding claims, wherein the signalling protocol is location service protocol.

13. Method according to claim 12, wherein the location service protocol is LLP protocol (LMU LCS Protocol).

14. Method according to any one of the preceding claims, wherein the location entity transfers the raw location data to another location entity using one or more signalling protocol(s).

15. Method according to any one of the preceding claims, wherein the signalling protocol used by the location entity to transfer the raw location data to the another location entity is control protocol.

16. Method according to claim 15, wherein the control protocol is SMLCPP (SMLC Peer Protocol).

17. Network-assisted mobile based location method, preferably GPS location method, allowing to detect the present location of a Mobile Station (MS), wherein the method uses a method according to any one of the preceding claims.

18. System for transferring location information in a mobile network, preferably for assisting in locating one or more Mobile Station(s) in the network, the system comprising at least one receiver outputting raw location data, and at least one location entity, wherein the receiver is adapted to transfer the raw location data to the location entity using one or more signalling protocol(s).

19. System according to claim 18, wherein the location information is received from a GPS system.

20. System according to claim 18 or 19, wherein the raw location data is GPS raw data.

21. System according to any one of claims 18 to 20, wherein the location entity is adapted to process the received raw location data so as to generate assistance data, preferably GPS assistance data.

22. System according to claim 21, wherein the location entity is adapted to transfer the assistance data to the mobile station.

23. System according to any one of the preceding system claims, wherein the location entity is a SMLC (Serving Mobile Location Centre).

24. System according to any one of the preceding system claims, wherein the Mobile Station is a mobile phone, portable computer, or User Equipment (UE).

25. System according to any one of the preceding system claims, wherein the network is a cellular communications networks.

26. System according to any one of the preceding system claims, wherein the signalling protocol is a signalling protocol of the communication network.

27. System according to any one of the preceding system claims, wherein the signalling protocol is a signalling protocol used in core network.

28. System according to any one of the preceding system claims, wherein the signalling protocol is a signalling protocol used in radio network.

29. System according to any one of the preceding system claims, wherein the signalling protocol is location service protocol.

30. System according to claim 29, wherein the location service protocol is LLP protocol (LMU LCS Protocol).

31. System according to any one of the preceding system claims, wherein the location entity is adapted to transfer the raw location data to another location entity using one or more signalling protocol(s).

32. System according to any one of the preceding system claims, wherein the signalling protocol used by the location entity to transfer the raw location data to the another location entity is control protocol.

33. System according to claim 32, wherein the control protocol is SMLCPP (SMLC Peer Protocol).

34. Use of the system according to any one of the preceding system claims in a network-assisted mobile based location system, preferably GPS location system, allowing to detect the present location of a Mobile Station (MS).
